(19) United States
(12) Patent Application Publication
(10) Pub. No.: US 2024/0147295 A1
(43) Pub. Date: May 2, 2024

(54) SPECTRUM SHARING IN MICROWAVE RADIO LINK NETWORKS

(71) Applicant: Telefonaktiebolaget LM Ericsson (publ), Stockholm (SE)

(72) Inventors: Lars-Erik LINDBERG, Härryda (SE); Jan SANDBERG, Frillesås (SE); Patrik OLESEN, Floda (SE)

(73) Assignee: Telefonaktiebolaget LM Ericsson (publ), Stockholm (DE)

(21) Appl. No.: 18/279,856

(22) PCT Filed: Oct. 8, 2021
(86) PCT No.: PCT/EP2021/077928

§ 371 Date: Aug. 31, 2023

(30) Foreign Application Priority Data
Mar. 5, 2021 (WO) PCT/EP2021/055672

(51) Int. Cl. H04W 28/02

(52) U.S. Cl. CPC H04W 28/0236; H04W 28/0263

(57) ABSTRACT

A control unit for a microwave radio link, RL, transceiver, wherein the control unit is arranged to: obtain information related to a current traffic capacity of the RL transceiver and a desired traffic capacity of the RL transceiver, and characterize at least one interference signal at least by determining, for each of the at least one interference signal, a respective frequency distance from a band edge of a communication frequency band of the RL transceiver to an interference frequency band of the interference signal, wherein, when the current traffic capacity is smaller than the desired traffic capacity, the control unit is arranged to increase a bandwidth of the communication frequency band by adjusting the communication frequency band of the RL transceiver in dependence of the determined frequency distance, and wherein, when the current traffic capacity is larger than the desired traffic capacity, the control unit is arranged to decrease the bandwidth of the communication frequency band by adjusting the communication frequency band of the RL transceiver in dependence of the determined frequency distance.

### TECHNICAL FIELD

The present disclosure relates to microwave radio link transceivers, and in particular to networks of microwave radio links. There are furthermore disclosed network management tools for managing one or more microwave radio link networks, as well as network nodes, computer programs, and computer program products.

### BACKGROUND

A microwave radio link is a highly directive point-to-point radio link used, e.g., for backhauling traffic from a cellular access radio base station to a core network, or for fibre replacement in high speed data traffic applications.

The capacity of such a microwave radio link depends, among other things, on the signal to interference and noise ratio (SINR) experienced by the microwave radio link receiver. This SINR deteriorates if a microwave radio link receiver is subject to radio interference from one or more neighboring radio transmitters. Thus, it is desired to minimize interference to the radio link.

Normally, microwave radio links are carefully deployed in relation to each other such that only very little interference occurs between microwave radio link transceivers located in the same local area. However, mistakes in the planning frequently occur, resulting in interference between microwave radio link transceivers. Also, as microwave radio link receiver sensitivity increases, and the propagation environment changes over time, non-negligible interference may still occur despite the careful frequency planning.

EP2883321A1 discusses the harmful effects of interference in microwave radio links and proposes some techniques for mitigating the interference.

WO2015070896A1 relates to interference from transmitters in adjacent channels, and to methods for mitigating such interference.

However, further improvement in interference mitigation techniques for microwave radio links is desired.

Spectral efficiency is becoming more and more important in microwave radio link networks. The higher the spectral efficiency, the more data can be communicated over a limited frequency band. This is an advantage since frequency spectrum is scarce and licenses for its use often very expensive.

There is a desire to maximize spectral efficiency in microwave radio link networks.

### SUMMARY

It is an object of the present disclosure to provide techniques for improving the spectral efficiency in a microwave radio link network. This object is obtained by a control unit for a microwave radio link (RL) transceiver. The control unit is arranged to obtain information related to a current traffic capacity of the RL transceiver and a desired traffic capacity of the RL transceiver, and to characterize at least one interference signal at least by determining, for each of the at least one interference signal, a respective frequency distance from a band edge of a communication frequency band of the RL transceiver to an interference frequency band of the interference signal. When the current traffic capacity is smaller than the desired traffic capacity, the control unit may increase a bandwidth of the communication frequency band by adjusting the communication frequency band of the RL transceiver in dependence of the determined frequency distance. Also, when the current traffic capacity is larger than the desired traffic capacity, the control unit may decrease the bandwidth of the communication frequency band by adjusting the communication frequency band of the RL transceiver in dependence of the determined frequency distance.

This way the available communication resources are more efficiently used in the network, leading to increased spectral efficiency in the network, which is an advantage. The proposed techniques are particularly suitable for autonomous implementations, where the adjustment is automatically performed with a minimum of manual configuration. Consequently, the disclosed techniques can be used to provide a network of radio link transceivers which dynamically adjust their respective communication frequency bands in dependence of desired traffic capacity in order to improve overall data throughput where needed.

According to aspects, the control unit is arranged to characterize the at least one interference signal by detecting a center frequency and a frequency bandwidth associated with the interference signal in a received signal of the RL transceiver and/or an adjacent frequency band edge associated with the interference signal. Efficient methods for this type of interference detection will be discussed in the following. The methods may be configured to rely on measurements made by individual radio link transceivers, and therefore do not require central coordination, which is an advantage.

According to aspects, the control unit is arranged to characterize the at least one interference signal by receiving data associated with the interference signal from a far end RL transceiver connected via radio link to the RI, transceiver. The interference data received from the far end is often more relevant compared to interference data measured at the near end transceiver. Thus, a more accurate interference characterization can be performed, which is an advantage.

According to aspects, the control unit is arranged to characterize the at least one interference signal by receiving data from a remote server, the data being associated with a bandwidth and a center frequency of the interference signal. This way interference data can be shared between radio link transceivers in an efficiency manner, which is an advantage. It has been realized that bandwidth and center frequency of the interference signal is sufficient in order to obtain an efficient implementation of the herein proposed techniques.

According to aspects, the control unit is arranged to adjust the communication frequency band of the RL transceiver by changing a center frequency of the communication frequency band in addition to the bandwidth of the communication frequency band. By adjusting center frequency of operation, a further increase in spectral efficiency may be obtained on the network level. This is because radio links may dynamically move around in frequency in dependence of the interference situation, in addition to dynamically adjusting the bandwidth of the communication frequency band.

According to aspects, the control unit is arranged to increase the bandwidth of the communication frequency band only in case a frequency distance to an adjacent interference signal meets a distance acceptance criterion. This way the potentially harmful effects from interference on a communication signal may be limited, which is an advantage. By only increasing the bandwidth of the communication frequency band in case there is sufficient frequency room, the operation of the radio link transceivers in the network of radio link transceivers is protected from too severe adverse effects of interference due to the dynamic adjustment of communication frequency bands. A similar effect may be obtained if the control unit is arranged to increase the bandwidth of the communication frequency band only in case a signal-to-interference-and-noise ratio (SINR) and/or a mean-squared-error (MSE) associated with the RL transceiver is above a respective distortion acceptance threshold.

According to aspects, the control unit is arranged to determine a relative priority value of the RL transceiver relative to one or more other RL transceivers, and to increase the bandwidth of the communication frequency band in case the relative priority value is above a priority threshold. This feature allows for a differentiation in priority between different radio links, which allows more freedom for an operator to configure the herein disclosed techniques in order to obtain one or more desired effects on the network level. Some radio links may be deemed more important than others, and can then be allowed to push other less important radio links out of their way. The relative priority value may, e.g., be determined by querying a remote server and/or a local priority database.

According to aspects, the control unit is arranged to periodically increase the bandwidth of the communication frequency band by a step-length with a predetermined probability, where the predetermined probability is configured in dependence of the relative priority value of the RL transceiver. This feature also allows for differentiating high importance radio links from less important radio links, which is an advantage since it allows an operator to optimize network function.

According to aspects, the control unit is arranged to adjust a modulation and/or coding configuration of the RL transceiver prior to increasing bandwidth of the communication frequency band. By adjusting modulation and/or coding of the radio link signal, the communication can be made more resilient to noise and distortion prior to the adjustment of the communication frequency band. This way the adjustment can be made more robust, and the communication more reliable.

According to aspects, the control unit is arranged to decrease the bandwidth in case a frequency distance to an adjacent interference signal is below a distance acceptance threshold. This feature also serves to reduce interference in the network of radio link transceivers, since a radio link can be made to back off in case it determines that an interfering radio link signal has come to close. The control unit may also be arranged to decrease the bandwidth in case SINR and/or MSE and/or MCS is below a respective distortion acceptance threshold.

According to aspects, the control unit is arranged to decrease the bandwidth down to but not beyond a pre-determined minimum bandwidth. This allows a radio link to maintain a minimum bandwidth of operation, which may be required in order to maintain radio link operation. Also, an operator may use this feature to conveniently configure a minimum capacity which should always be available over some given radio link hop.

According to aspects, the control unit is arranged to insert a guard carrier adjacent to the communication frequency band configured to shield against adjacent interference signals. This feature allows to push other radio links out of the way in a convenient manner without risking increased interference in a primary communication frequency band of the radio link.

According to aspects, the control unit comprises a machine learning structure configured to predict the future traffic pattern of the RL transceiver. Machine learning structures may be exploited to predict future traffic patterns in an efficient manner. Machine learning structures will be discussed in more detail in the following. Generally, machine learning structures can be exploited in order to predict, e.g., traffic patterns which are otherwise difficult to detect by other means.

According to aspects, the control unit is configured to increase the bandwidth of the communication frequency band up to but not beyond a block license frequency band. This means that the operation can be conveniently confined to, e.g., a block-license owned by a given operator.

There is also disclosed herein methods, control units, circuits, network nodes, and computer program products associated with the above-mentioned advantages.

### BRIEF DESCRIPTION OF THE DRAWINGS

The present disclosure will now be described in more detail with reference to the appended drawings, where:

FIG. 1 shows an example communication network;

FIG. 2 is a graph showing a received radio signal level vs frequency;

FIG. 3 schematically illustrates a microwave radio link receiver;

FIGS. 4A-B show example reports of detected interference signals;

FIG. 5 illustrates an interference situation in a microwave radio link network;

FIG. 6 schematically illustrates a radio link network implementing dynamic spectrum sharing;

FIGS. 7A-B illustrate a first example of a dynamic spectrum sharing operation;

FIG. 8 is a flow chart illustrating an example method;

FIGS. 9A-B illustrate a second example of a dynamic spectrum sharing operation;

FIGS. 10A-B illustrate a third example of a dynamic spectrum sharing operation;

FIG. 11 is a flow chart illustrating example methods;

FIGS. 12-13 schematically illustrate example network nodes.

FIG. 14 schematically illustrates processing circuitry; and

FIG. 15 shows a computer program product;

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

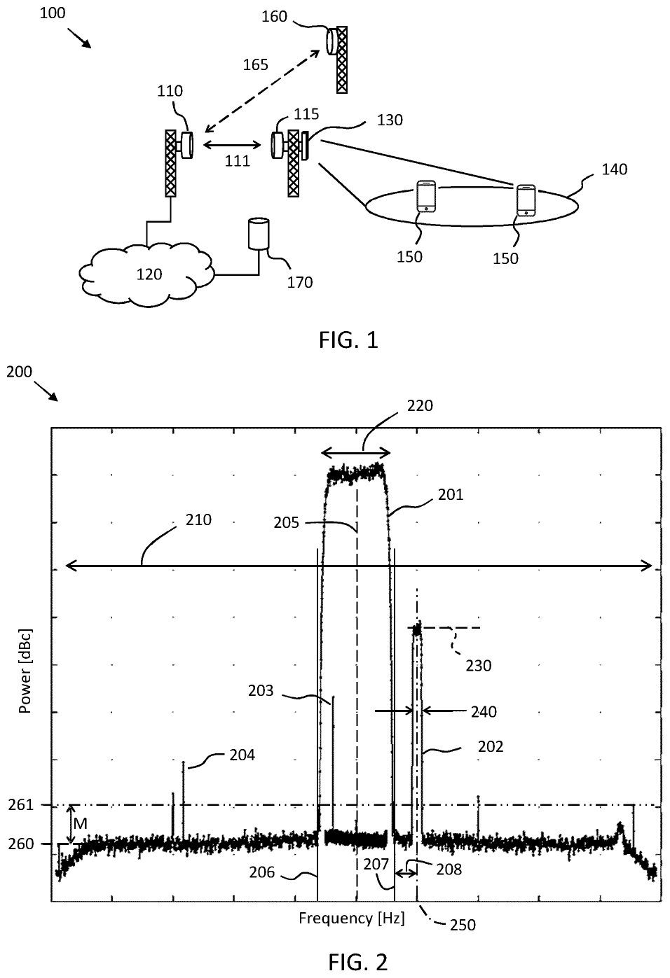

FIG. 1 illustrates an example communication system 100 comprising one or more radio base stations 130 configured to serve a number of wireless devices 150 comprised in a cellular coverage area 140. The communication system 100 may be a fourth generation (4G), fifth generation (5G) or even a sixth generation (6G) network defined by the third generation partnership program (3GPP), or some other type of communication network. It is appreciated that the techniques disclosed herein are not limited to any particular type of communication system but can be applied in most wireless systems comprising microwave radio links.

A microwave radio link 111 between a pair of microwave radio link transceivers 110, 115 is used to backhaul data traffic between the wireless devices 150 and a core network 120. As mentioned above, a microwave radio link transceiver is a radio transceiver operating at high carrier frequency, e.g., above 6 GHz or higher, and arranged with a highly directive antenna to provide a stable, high throughput, data connection between two fixed points. A microwave radio link is often referred to a point-to-point microwave radio link for these reasons. It is appreciated that the requirements in terms of error rates, packet loss, and the like are often much stricter for a backhaul link compared to a radio link between user equipment and a radio base station in the access network.

The throughput and robustness of the microwave radio link 111 is at least in part determined by the signal to interference and noise ratio (SINR) experienced at the receiver 110. This SINR deteriorates if the receiver is subject to radio interference 165 from an external source 160, such as another radio link transceiver in the network of radio link transceivers.

Normally, the deployment of fixed point-to-point radio links is planned such that neighboring, and therefore potentially interfering, radio links are assigned different communication frequency bands in which to operate. This communication frequency band often comprises a transmit frequency band and a receive frequency band, potentially separated by a duplex distance in a known manner. Due to propagation model inaccuracies and other uncertainties, large margins are often used in order to ensure error free radio link operation. These large margins are inefficient from a spectral efficiency point of view. The techniques for spectrum sharing which will be described below offer a mechanism which enables reducing these large margins, thereby improving the spectral efficiency in the communication system.

The communication frequency band assignments in a network of radio link transceivers are normally fixed, i.e., comprise a fixed center frequency of operation and a fixed bandwidth for communication. Such fixed frequency planning in a network of radio links is also inefficient from a spectral efficiency point of view since the spectrum use is not adapted to the current traffic conditions. For instance, suppose that a first radio link serves one or more access points close to an office building, where many subscribers generate data traffic during office hours, while a second radio link serves a residential area with very few subscribers during office hours. The traffic load on the first radio link is then probably much higher, perhaps even saturated (close to peak capacity), during office hours when the second radio link is perhaps not used very much. The traffic load conditions then change after office hours, when instead the second link may be more loaded with traffic compared to the first link. The techniques for spectrum sharing which will be described below also offer a mechanism where two or more radio links can adjust their communication frequency bands in dependence of a current traffic load on the link, thereby improving the spectral efficiency in the communication system.

FIG. 2 shows an example graph 200 of an example received radio signal, such as a signal received by the microwave radio link 111 illustrated in FIG. 1, where received signal power in dBc is plotted vs frequency in Hz. The illustrated received signal is associated with an intermediate frequency (IF) bandwidth 210. This IF bandwidth may be determined by the capabilities of an analog to digital converter (ADC) and/or by a configured analog filtering bandwidth in a front-end portion of a microwave radio link receiver. The received radio signal comprises an information signal 201. This component of the received radio signal is the part which carries the useful information of the radio link, e.g., the actual backhaul data traversing the microwave radio link 111 in FIG. 1. Microwave radio links are normally designed to carry single carrier quadrature amplitude modulated (QAM) information signals, but other options certainly exist. Such other options comprise, e.g., orthogonal frequency division multiplexed (OFDM) information signals, as well as code-division multiple access (CDMA) type signals. The information signal is comprised in the communication frequency band 220. As noted above, most radio links generate traffic in one frequency band in one direction and traffic in another frequency band in the other direction. However, to not complicate the disclosure, a radio link is herein assumed to operate in a single communication frequency band.

A plurality of interference signals 202, 203, 204 are also present. Some of these interfering signals are undesired since they potentially degrade the SINR seen at the receiver of the information signal 201, without carrying any traffic in the network. Some other interference signals are due to other data transmissions in the network, and therefore not undesired from a network perspective.

Some of the interfering signals 202, 204 are out-of-band interference signals, meaning that they comprise signal energy which is mainly located outside of the communication frequency band 220. However, there is also in-band interference 203 which contributes directly to a reduction in SINR. Generally, an interference signal is associated with a signal power level 230, a frequency bandwidth 240, and a carrier frequency 250 which may also be referred to as a center frequency. These measures are generally known and will therefore not be discussed in more detail herein.

Suppose now that a radio link receiver is able to detect and characterize interference signals in some frequency band extending beyond the communication frequency band 220. The radio link receiver may, e.g., be able to determine an interference free distance from the communication frequency band 220 to one or more interference signal frequency band edges. An example is the distance, i.e. the frequency distance 208, illustrated in FIG. 2. This information can then be used to autonomously adjust the communication frequency band to make use of the available frequency resources. In the example of FIG. 2, the communication frequency band 220 could be extended to the lower frequencies, perhaps up to the interference signal 204 or even further in case the modulation and coding scheme is adapted to account for the interference signal 204, without interfering with the transceiver communicating at center frequency 250. Thus, if a given radio link desires to increase its traffic capacity, it may autonomously extend its communication frequency band to cover unused spectrum, based on a characterization of the different interference signals in vicinity of its communication frequency band 220.

At the same time, a radio link which is currently operating far from its peak capacity given the current communication frequency band may back off, i.e., reduce the bandwidth of its communication frequency band, in order to make more room for other radio links. In the example of FIG. 2, this could perhaps mean that the rightmost band edge of the communication frequency band 220 is shifted to the left, in order to make room for an expansion of the transceiver communicating at center frequency 250. This operation can also be performed autonomously.

Now, in case an entire network of radio links is deployed in some area, perhaps also in a block-licensed frequency band of operation, and this type of function is enabled, then it would be possible for the radio links to autonomously increase and decrease communication frequency bands, and optionally also shift center in dependence of a difference between a current traffic capacity and a desired traffic capacity.

With reference also to FIG. 14, which will be discussed in more detail below, the proposed techniques can be realized by a control unit 1400 for a microwave radio link (RL) transceiver 110, 115, 160. The control unit 1400 is arranged to obtain information related to a current traffic capacity of the RL transceiver and a desired traffic capacity of the RL transceiver. Traffic capacity can be measured, e.g., in terms of an information bit-rate as function of time, bits per second (bps). Traffic capacity can also be indicated by a packet rate.

Generally, a current traffic capacity can be determined based on the current modulation and coding scheme (MCS), i.e., how many useful information bits which can be transmitted with every modulation symbol, and the current symbol rate, which is primarily a function of the communication frequency band of operation. It is understood that the current traffic capacity on forward and reverse links over a microwave radio link hop may differ, perhaps since one end of the hop may experience different interference compared to the other end and therefore use a different modulation and/or channel code.

The desired traffic capacity is a measure of the traffic load on the link which it is desired to carry. For instance, the desired traffic capacity may be determined based on a buffer fill level of the microwave radio link, or a measure of traffic buffer delay over the link. Packet drop rate for a traffic handling function of the radio link can of course also be used as a measure of the desired traffic capacity, since a significant packet drop rate may be indicative of a saturated radio link. The desired traffic capacity can of course also be a predicted future need for throughput. For instance, the radio link control unit may keep a record of traffic flow over the radio link as function of, e.g., day and time of day, and make predictions of future desired traffic rates based on this data. A machine learning structure, such as a neural network, may be configured to predict such future desired traffic capacities. For instance, a neural network or other machine learning structure may be trained using historical data of traffic load over the link.

To summarize, according to some aspects, the desired traffic capacity of the RL transceiver is a function of a current traffic load and/or an average buffer fill level of the RL transceiver.

According to some other aspects, the desired traffic capacity of the RL transceiver comprises a predicted future traffic pattern of the RL transceiver. The control unit 1400 optionally comprises a machine learning structure configured to predict the future traffic pattern of the RL transceiver.

A radio link, as mentioned above, normally uses one frequency band in each direction over the hop. It is noted that the techniques proposed herein are possible to use with symmetric links, where the frequency bands on forward and reverse direction over a radio link hop are of equal width. However, additional advantages can be obtained if the radio link is allowed to operate in an asymmetric fashion, such that it uses more frequency resources in one direction compared to the other direction. This improves the possibility to adjust to uneven traffic flows in forward and reverse direction over the link.

The control unit 1400 is arranged to characterize at least one interference signal 202 at least by determining, for each of the at least one interference signal 202, a respective frequency distance 208 from a band edge 206, 207 of the communication frequency band 220 of the RL transceiver to an interference frequency band of the interference signal 202. A band edge is herein taken to be the start 206 and end 207 of the communication frequency band 220. The start and end location in frequency may, e.g., be defined as the frequency where the communication frequency band power equals the noise floor power 260, although other definitions are certainly possible.

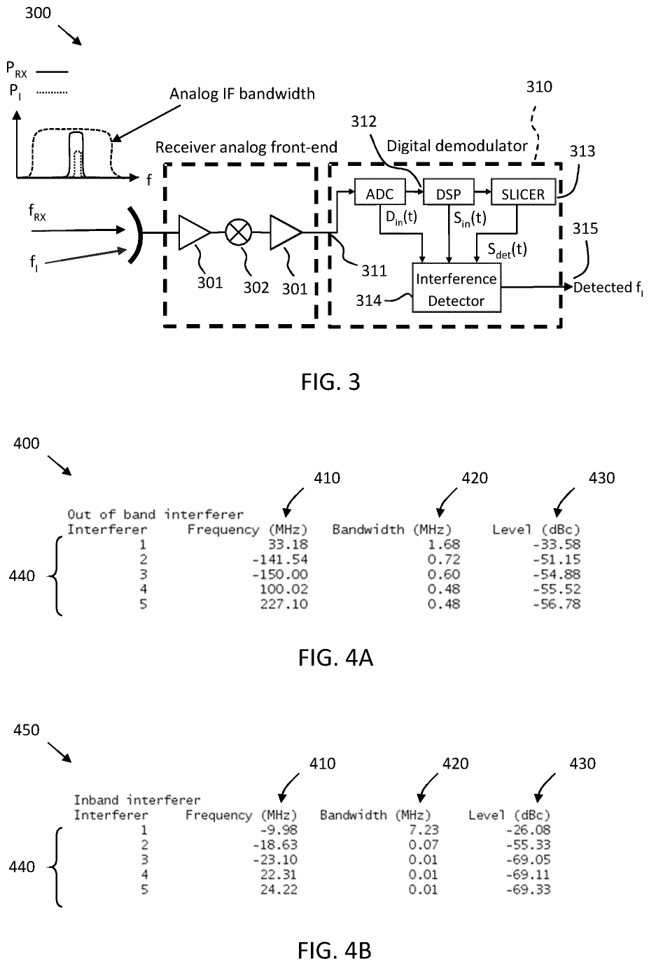

FIG. 3 shows an example microwave radio link receiver 300 according to some of the teachings herein, which comprises functionality for characterizing one or more interference signals. This receiver 300 may, e.g., form part of a microwave radio link transceiver 110, such as that illustrated in FIG. 1. The receiver 300 comprises an analog front-end with amplifiers 301 and mixers 302. Two signals are received by the analog front-end, an information signal f_{RX} such as the information signal 201 discussed in connection to FIG. 2 above, and an unwanted interference signal f₁, such as, e.g., any of the interference signals 202, 203 and/or 204. The analog front-end is associated with an analog IF bandwidth which is wider than the bandwidth of the information signal. An ADC is used to convert the received radio signal into digital domain, which digital signal is then arranged to be processed by a digital signal processing unit (DSP) before being fed to a slicer. The slicer module 313 is arranged to detect an information signal Sdet, i.e., the data carrying signal 201 which was exemplified and discussed in connection to FIG. 2 above. The slicer performs data detection, i.e., recovers data carried by the information signal. In case the information signal is a QAM-modulated signal, the slicer is basically a series of threshold comparisons to detect a sequency of QAM-modulated information symbols. An OFDM modulated signal requires a bank of threshold devices arranged to detect information symbols on a plurality of subcarriers, in a known manner. Other modulation formats may require other types of slicer modules. Principles and mechanisms of data detection by a slicer module are generally known and will therefore not be discussed in more detail herein.

The ADC, the DSP, and the slicer forms part of a digital demodulator 310. This demodulator comprises an input port 311, 312 arranged to receive the radio signal Din, Sin. Note that the “radio signal” is to be interpreted broadly in this context. It may be construed as the analog input samples to the ADC, the digital output samples Din from the ADC, and/or an intermediate output Sin from the DSP, such as a down-sampled and filtered version of the output samples from the ADC. All of these radio signals are generally functions of time t, but may also comprise separate functions over frequency, as in an OFDM modulated system comprising a plurality of subcarriers. According to some other aspects the received radio signal Din is associated with an IF bandwidth 210 in excess of a communication frequency band 220 of the information signal Sdet. According to some other aspects the received radio signal Sin comprises a digital signal associated with a bandwidth smaller than the IF bandwidth 210 of the analog radio front end. The signal Sin may be sampled at twice the information symbol rate, or at the information symbol rate of the information signal, or at some other rate not necessarily an even multiple of the symbol rate.

An interference detection module 314 is arranged to determine a difference signal as a difference between the received radio signal Din, Sin, and the detected information signal Sdet. This operation basically amounts to removing the information signal from the received signal, essentially leaving the interference signal or signals and receiver noise as remainder. The difference operation may be implemented as a difference in complex amplitude, or as a frequency difference operation, i.e., a filtering to remove a frequency band of the information signal from the received radio signal IF bandwidth 210. It is appreciated that the difference operation may comprise a reconstruction of the information signal, e.g., by pulse shaping or the like. It is also appreciated that the difference operation may comprise a phase and/or delay adjustment to account for a phase difference and/or a difference in delay, respectively, between the received radio signal and the information signal. Conceptually, the interference detection module receives a signal similar to that plotted in FIG. 2 over the IF bandwidth, and also a representation of the information signal 201. A difference operation between these two corresponds to removing the information signal 201 from the signal content, leaving just the interference 202, 203, 204.

The interference detection module 314 is arranged to detect the one or more interference signals 202, 203, 204 by identifying signal content comprised in the difference signal. With reference again to FIG. 2, suppose that a threshold level, e.g., set in dependence of the noise floor power 260, has been determined as coinciding with the noise floor of the receiver. Any signal having a power above this threshold level is then defined as an interference signal. Of course, other threshold levels can be selected. For instance, the threshold level 261 which is determined by adding a configurable margin value M to the noise floor level can also be used.

The interference detection module 314 is furthermore arranged to associate at least one of the detected interference signals 202, 203, 204 with one or more respective identification features. Some example identification features will be discussed below. In general, an identification feature of a detected interference signal is some form of characterizing feature that can be used to distinguish the interference signal from other interference signals. The demodulator 310 comprises an output port 315 arranged to output data 400, 450 indicative of the one or more identification features. This output port may be the same output port which is used to output the detected data carried by the information signal, or a separate output port.

Thus, the demodulator 310 is arranged to receive a radio signal comprising an information signal, and to detect information carried by the information signal by the slicer 313. In addition, the demodulator also outputs some form of data indicative of the interference, which is present in the received radio signal, where the interference can be either in-band or out-of-band, or both. The data indicative of the interference may take many different forms and is to be construed broadly in this context. For instance, this data may simply comprise a flag indicative of a detected interference component in the received radio signal. More advanced examples of the interference data which can be output from the demodulator 310 is shown in FIGS. 4A and 4B. With reference also to FIGS. 4A and 4B, identification features of interest which can be output from the demodulator 310 may comprise any of a signal power level 230, 430 of the detected interference signals, a frequency bandwidth 240, 420 of the detected interference signals, a carrier frequency, or centre frequency, 250, 410 of the detected interference signals, and/or a polarization distribution of the detected interference signal, i.e., an average ratio of signal power in a first polarization, such as a horizontal polarization, compared to a polarization orthogonal to the first polarization.

The data 400, 450 indicative of the one or more identification features optionally comprises a list 440 of a pre-determined number of detected interference signals as shown in FIGS. 4A and 4B. These detected interference signals may be sorted or otherwise arranged according to a severity criterion. This severity criterion may, e.g., be the power level of the interference, and/or if the interference is in-band or not. Separate reports may also be issued for in-band and for out-of-band interference signals. Note that the interference signal characterizations shown in FIGS. 4A and 4B are mere examples. The interference signal characterizations may also comprise just a distance to the closest interference signal band edge on either side of the communication frequency band 220, possibly complemented by the power or severity of the detected interference signals.

Given information associated with the interference signals in vicinity of the communication frequency band 220, the control unit 1400 may set out to adjust its communication frequency band of operation in a dynamic fashion. Consequently, when the current traffic capacity of the RL is smaller than the desired traffic capacity, i.e., in case there is a traffic capacity deficit, the control unit 1400 may be operable to increase the bandwidth of the communication frequency band 220 by adjusting the communication frequency band 220 of the RL transceiver in dependence of the determined frequency distance to the one or more interference signals. Also, when the current traffic capacity is larger than the desired traffic capacity, i.e., when there is a traffic capacity surplus, the control unit 1400 is arranged to decrease the bandwidth of the communication frequency band 220 by adjusting the communication frequency band 220 of the RL transceiver in dependence of the determined frequency distance, in order to make room for other radio links that may experience a traffic capacity deficit.

Note that the radio link control unit 1400 performs the adjustments in dependence of the determined frequency distance to the one or more interference signals. This means that the radio link controller may in fact not go ahead with an increase in communication bandwidth in case the interference situation does not allow it, as will be discussed in more detail below. This may also mean that the radio link controller may not go ahead with a communication frequency band decrease if the interference situation indicates that such a decrease would not be exploitable by some other radio link in the network of radio links. An example of this proposed method of operating a radio link transceiver will be discussed in detail below in connection to FIG. 8.

According to some aspects, the control unit 1400 is configured to increase the bandwidth of the communication frequency band 220 up to but not beyond a block license frequency band. In fact, operation by a plurality of radio links within a block license frequency band, i.e., a continuous range of frequencies managed by a single radio link operator, is advantageous, since the radio links may then be configured to operate autonomously or at least semi-autonomously to increase and/or decrease the bandwidth of the communication frequency band 220 within the block license managed by the operator.

It is furthermore noted that additional advantages may be obtained if the control unit 1400 is also arranged to adjust the communication frequency band 220 of the RL transceiver by changing a center frequency 205 of the communication frequency band 220 in addition to the bandwidth of the communication frequency band 220. This way the control unit 1400 may relocate the communication frequency band, and thereby obtain a potentially larger increase in bandwidth compared to if the center frequency was kept fixed at all times.

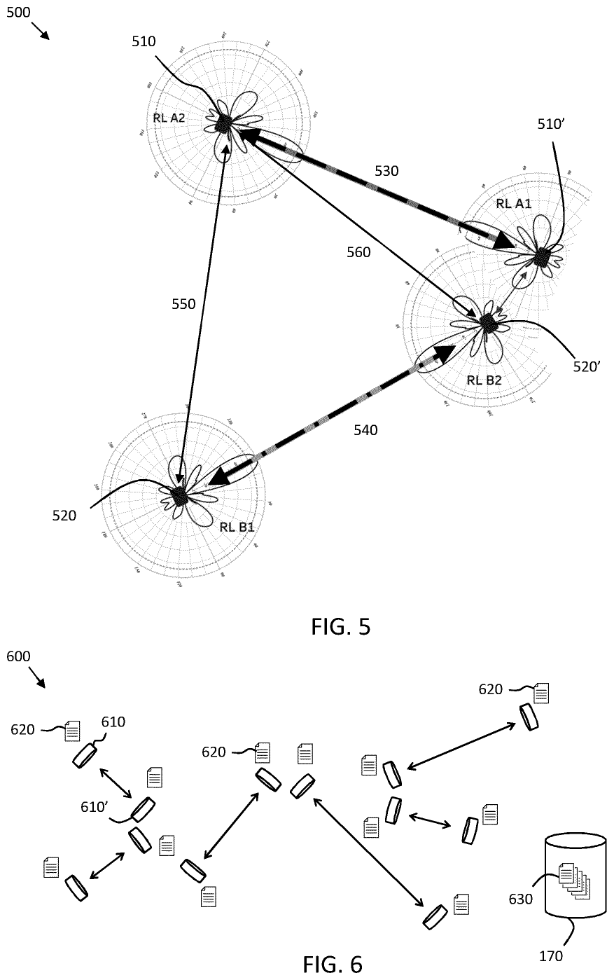

FIG. 5 illustrates a scenario 500 where two radio link transceiver pairs 510, 510′, 520, 520′ are set up to communicate data over respective radio links 530, 540. The two radio links are spatially separated, but due to sidelobe emission 550, 560 still interfere with each other. It can sometimes be difficult to model these rather complicated interference dependencies between radio links in a network of radio link transceivers, which is one of the reasons that large safety margins are often used—with obvious drawbacks when it comes to network spectral efficiency. However, by the techniques disclosed herein, one or both of the radio links will dynamically adjust their respective communication frequency bands in order to make the best use of the available spectrum, without causing interference to the other radio link transceiver.

FIG. 5 makes it clear that it is the interference situation at the far end radio link transceiver which is of primary importance when deciding on a suitable communication frequency band for the near-end radio link transmitter. For instance, the radio link transceiver 520 is being interfered by the radio link transceiver 510, and if it wishes to increase its traffic capacity by adjusting the communication frequency band, it is the frequency band of operation of the transmitter at 520′ which should be adjusted, not the transmitter at the transceiver 520. The same goes for the radio link 530. If the traffic capacity of the radio link 530 is to be increased in the direction of the transceiver 510, then it is the interference situation at the transceiver 510 which should determine the adjustment made to the transmitted signal of the transceiver 510′. For these reasons, the control unit 1400 may be arranged to characterize the at least one interference signal 202 by receiving data associated with the interference signal from a far end RL transceiver connected via radio link to the RI, transceiver. This function then becomes akin to an adaptive modulation feature (AdMod) or an automatic transmit power control (ATPC) feature, where the operation of a transmitter is based on measurement data generated at a receiver of the transmitted signal.

FIG. 6 illustrates a network of radio link transceivers 600, where each radio link comprises first and second radio link transceivers 610, 610′ arranged for point-to-point communication. The point to point communication takes place in a respective communication frequency band, like the communication frequency band 220 discussed above. Suppose now that at least some of the transceivers in the radio link network periodically monitors the interference situation in order to characterize interference signals in vicinity of the own communication frequency band, i.e., a list 620 such as the lists 400, 450 discussed above in connection to FIGS. 4A and 4B. Each radio link transceiver pair can then determine if there is room to extend the current communication frequency band, by determining the frequency distance to the closest interferer to the left and/or to the right of the communication frequency band. If there are no interferes detected, e.g., within the IF frequency band, then the radio link is free to extend its operation to consume more frequency resources. However, if there is an interferer to one or both sides of the communication frequency band, then the radio link may only extend its operation up to some margin from the band edge of the interference signal. Such an extension of the communication frequency band used by one radio link may be conditioned on their being a need for more communication resources. For instance, the radio link may evaluate a current traffic capacity and a desired traffic capacity, and only increase its bandwidth in case the current traffic capacity is smaller than the desired traffic capacity. In a similar manner, one or more radio links in the network of radio links may choose to decrease the width of the communication frequency band in which it is operating, in case the current traffic capacity exceeds the desired traffic capacity, i.e., if the current traffic capacity of the radio link is not fully utilized.

Each radio link transceiver pair may evaluate the inference situation on its own, using, e.g., some of the techniques discussed above, or it may obtain the interference data from some other entity, like a remote server 170. This remote server may gather interference data throughput the radio link network and maintain a database of interference signals. In fact, the remote server does not necessarily need to obtain measurement data from the different radio link receivers as discussed in connection to FIG. 3, it may characterize interference signals also in other ways, such as by deploying passive listener devices configured to detect interference signals at some frequency range. The radio link transceivers can then obtain data related to the interference situation from the remote server 170, prior to adjusting the communication frequency band. In other words, the control unit 1400 may be arranged to characterize the at least one interference signal 202 by receiving data from a remote server 170, the data being associated with a bandwidth and a center frequency of the interference signal and/or a frequency band edge of the interference signal.

According to some aspects of the herein disclosed techniques, the control unit is arranged to characterize the at least one interference signal 202 by detecting a center frequency 250 and a frequency bandwidth 240 associated with the interference signal 202 in a received signal of the RL transceiver. This detection may be realized by the techniques discussed above in connection to FIG. 3, or by some other known technique. Detecting a center frequency and a bandwidth is to be construed broadly herein to mean any of actually listing the center frequency and bandwidth as in the examples of FIGS. 4A and 4B. However, the techniques disclosed herein may also be based on the detection of an adjacent frequency band edge of an interference signal.

For completeness, it is also noted that features of an interfering signal such as center frequency, bandwidth, and power are identification features which can be used to identify the source of the interference. For instance, suppose that the radio link receiver 110 in FIG. 1 is subject to strong in-band interference at a first center frequency. If an operator is able to determine this first center frequency, then the operator can compare this interfering signal center frequency to the center frequencies of neighboring transmitters, and thus hopefully be able to identify the culprit. Interference mitigating measures can then be taken to reduce the interference in the microwave radio link network, e.g., by changing the frequency planning in the network, and/or by adjusting output powers in the network or adjusting the operating parameters of the interference radio link receiver. Thus, the interference characterization data can be used for many things, not just for dynamically adjusting the communication frequency band of one or more radio links.

A received radio signal like that plotted in FIG. 2 is associated with a noise floor power level 260, which among other things comprises thermal noise generated at the receiver. This type of noise floor can be used as a pre-determined threshold level. The noise floor level can be determined, e.g., by averaging away transient effects, and removing strong signal components from the determination. Any signal content within the IF frequency band having a power above the threshold level is likely either an information signal or due to an interfering transmitter. Thus, interference signals can be identified by comparing signal content across the IF bandwidth with the threshold level. Of course, a margin M can be added to the noise floor level, such that the threshold level 261 is higher than the receiver noise floor by the margin M. Such a threshold level 261 is illustrated by the dash double-dotted line in FIG. 2.

The output data from the demodulator 310 in FIG. 3, indicative of the one or more identification features can, as mentioned above, be used to identify interfering transmitters, in order to take interference mitigating measures or to notify regulatory bodies about the interference. Once an interfering radio transmitter has been identified, adjustments can be made in the network to mitigate the effects of this interference. This identification of interfering transmitters in a communication system, like the communication system 100 discussed above in connection to FIG. 1, can be implemented in a microwave radio link transceiver 110 and/or in a network node arranged to perform a network operations and maintenance, OAM, function in a network of the plurality of microwave radio link transceivers 110, 115, 160. The network node then implements a tool for managing interference in a network comprising a plurality of microwave radio link transceivers.

By identifying and classifying an interferer by, e.g., frequency, power and/or bandwidth it will be possible to initiate actions to mitigate the interference. By separating failure modes caused by interference from other failure modes that cause bit errors or degraded capacity, it becomes possible for an operator to take appropriate action to resolve the problem. Without the knowledge of current interfering signals, an operator may be more likely to assume that a problem is due to malfunction of the interfered radio link. The interferer identification by power level, frequency band, and bandwidth, makes it possible to classify the interferer as being comprised in the operators own network or part of some external network. Also, if the interferer is within a licensed band but from an external source, a complaint report can be sent to frequency regulatory authorities. These techniques may be advantageously combined with the type of dynamic adjustment of the communication frequency bands of operation discussed above.

One possible use-case for the receiver 300 in FIG. 3 is when a new radio link transmitter is installed within the same network and interferes with a receiver of another radio link. This can also be caused by a change in the environment, e.g. new building, billboard, or similar, or a change in configuration of an existing transmitter. In all these cases the receiver 300 is able to identify this in-band interferer and if the channel frequency and modulation bandwidth match with some known transmitter within the network, this can be tested by executing a handshake orchestrated by the central controller unit. The handshake can be done by changing power or frequency by a known pattern of the suspected interfering transmitter. If the interfering signal in the receiver follow the same pattern, then we know that transmitter is the source.

In-band interferers may also be part of some un-known network. This can for instance happen if another operator installs a new link, or makes a change to an existing transmitter configuration, or a change in environment occurs which causes a reflection of radio signal energy in some new direction. If the interferer characteristics like channel frequency and bandwidth is not matching any of the radio link transmitters in the area, it i most likely due to an external interferer. The identified characteristics of the interferer can then be sent to a network controller unit. The network controller provides the network operator with an incident report with information about the characteristics of the interferer such as the frequency, bandwidth and received signal strength of the interference signal.

The proposed receiver 300 can also detect very low, and non-severe, interference. There can be a situation where a receiver has a very weak in-band interferer that is not strong enough to, in normal operation conditions, make a noticeable impact on the radio link performance. With the methods of detecting interferers proposed herein, it will still be possible to detect and report the interferer to the network operator.

Interferers can be detected within the full receiver bandwidth and also at the band edges, which is an advantage. When an interferer and the interfered link has different bandwidths, the impact can be intermittent, e.g. degrade performance during rain, but have little or no impact during normal operating conditions.

Various interference mitigation techniques can be used in case interference is detected. For instance, in case the operator holds a block license, other channel assignments can be tested to see if the interference situation improved. Thus, the techniques proposed herein allow an operator to better optimize usage of licensed frequencies. In the case where the interferer is identified as being part of the operator's network, it will normally be possible to reconfigure the involved radio links to resolve the interfering situation. This can, for instance, be achieved by any of decreasing the interferer output power, changing the radio channel used by the interfering and/or the interfered radio link, activating automatic transmit power control (ATPC) at the interferer, and/or increasing the output power at the far end of the interfered radio link. In case the interfering equipment resides outside the operators own network, it is possible to perform actions such as: increasing output power in the interfered direction, changing channel at the interfered radio link, and/or notifying a regulatory body about the interference situation.

According to some aspects, the control unit 1400 is arranged to determine a relative priority value of the RL transceiver relative to one or more other RL transceivers, and to increase the bandwidth of the communication frequency band 220 only in case the relative priority value is above a priority threshold. This means that a high priority radio link transceiver may be able to force its way to more communication resources, by increasing the frequency bandwidth of the communication frequency band even if there is an interference signal present. As long as the interfering transceiver also implements the techniques discussed herein, it will cede the communications resources as soon as it senses the rise in interference.

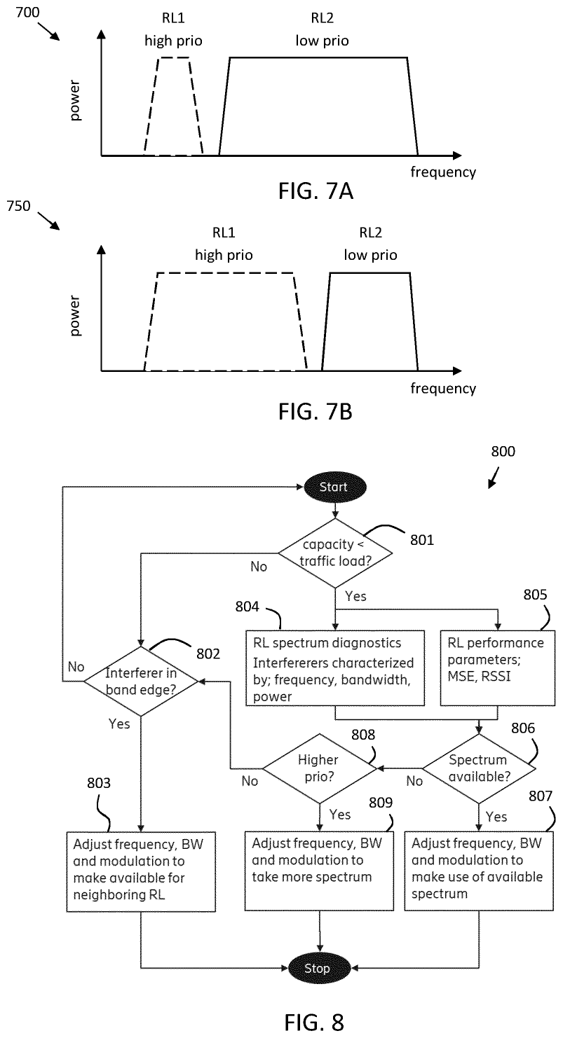

FIGS. 7A and 7B schematically illustrate the proposed concepts by graphs of transmission spectra power as function of frequency. The Figures show two radio links, each comprising its respective communication frequency band. A first communication frequency band used by a first radio link is illustrated by a dashed line spectrum while a second communication frequency band used by a second radio link is illustrated by a solid line spectrum. Initially, as shown in the graph 700, the first radio link operates in a much smaller frequency band compared to the second radio link. However, the first radio link then becomes saturated with traffic, and desires to expand its communication frequency band of operation. Since the first radio link has been assigned a high priority relative to the second radio link, it starts to expand its communication frequency band of operation. This causes an increase in distortion at both links, but the second radio link determining that the interference is generated by the high priority link, automatically backs away to a smaller communication frequency band, as illustrated in the graph 750 of FIG. 7B. It is noted that the center frequencies of operation are also changed in the example of FIG. 7B.

The relative priority value can, for instance, be obtained by the control unit by querying the remote server 170 and/or a local priority database. One low complexity implementation of this priority value is to simply hardcode a low frequency priority value and a high frequency priority value, which indicates if the radio link has a higher priority with respect to the interference signals lower in frequency and higher in frequency, respectively. This is one example of a relative priority value determined as a predetermined binary priority value. Other ways to implement a binary priority value is to simply hard-code a binary high priority flag, where a radio link with the high priority flag set will force other transceivers out of its way, while a radio link transceiver without the flag set will yield to other radio transceivers.

The configured priority value may, generally, be configured as a function of time and/or date, such that one link may be a high priority link during, e.g., office hours, while another link is a high priority link outside of office hours.

The control unit 1400 may optionally be arranged to periodically increase the bandwidth of the communication frequency band 220 by a step-length with a predetermined probability, where the predetermined probability is configured in dependence of the relative priority value of the RL transceiver. This causes high priority radio links to on average try to consume more communication resources compared to lower priority links, which may be a desired behavior in some radio link networks.

It is appreciated that an increase in bandwidth may give rise to an increase in noise floor in case an interference signal is being approached. To prevent bit errors, and potential information loss, due to the increased interference power experienced by both radio links, the control unit 1400 may optionally be arranged to increase the bandwidth of the communication frequency band 220 only in case a frequency distance to an adjacent interference signal 202 meets a distance acceptance criterion. Thus, if an interference signal is too close, the radio link controller may decide to postpone or even cancel a planned increase in the bandwidth of the communication frequency band 220. In a similar manner, the control unit 1400 may be arranged to increase the bandwidth of the communication frequency band 220 only in case a signal-to-interference-and-noise ratio (SINR) and/or a mean-squared-error (MSE) associated with the RL transceiver is above a respective distortion acceptance threshold.

To protect the data transmission against bit errors and packet loss, the control unit 1400 may be arranged to adjust a modulation and/or coding configuration of the RL transceiver prior to increasing bandwidth of the communication frequency band 220. This adjustment can make the radio link data transmission more robust against interference, which may arise as the frequency bandwidth of the communication frequency band is adjusted. In particular, a more robust transmission can be obtained by switching to a stronger error correcting code, and/or switching to a lower order QAM modulation. Once the transmission conditions of the new communication frequency band have been evaluated, e.g., in terms of MSE or the like, the MCS can be reverted back to the desired MCS.

The radio link controller may also be configured to cede bandwidth by reducing the frequency width of the communication frequency band 220. According to some aspects, the control unit 1400 is then arranged to decrease the bandwidth in case a frequency distance to an adjacent interference signal 202 is below a distance acceptance threshold, and/or to decrease the bandwidth in case SINR and/or MSE and/or MCS is below a respective distortion acceptance threshold, and/or to decrease the bandwidth down to but not beyond a pre-determined minimum bandwidth.

To summarize, according to some aspects of the present disclosure, each radio link transceiver may be configured to adjust its communication frequency band autonomously, based on a characterization of the interference in vicinity of its communication frequency band and possibly also in dependence of a relative priority value and a measure of distortion as discussed above. This means that a group of radio link transceivers can be configured to autonomously adjust consumed spectral resources in dependence of traffic load, without any central coordination, which is an advantage. Also, there is no need for advanced radio propagation simulations or large margins to make sure significant interference does not arise in the network, since the radio links will instead adjust to the interference situation in an autonomous manner.

FIG. 8 illustrates an example 800 of this type of operation. According to this example, the radio link first determines 801 a current traffic capacity and a current traffic load. If the current capacity if larger than the current traffic load, no additional communications resources are needed. The radio link then proceeds to investigate 802 if there are any interferers close to a band edge of the communication frequency band. If there is no interferers present, then no action is taken. However, if an interference is detected, then the radio link proceeds to adjust 803 the bandwidth of the communication frequency band, in order to free up additional communications resources for neighbouring radio links.

If the current capacity is instead smaller than the current traffic load, then it means that there is a desire for more traffic capacity, i.e., there is a traffic capacity deficit given the current traffic load and available communications resources. When this happens, the radio link investigates 804 what interference is present, and also determines 805 a number of radio link performance metrics, such as mean-squared error (MSE), received signal strength indicator (RSSI), and the like. If it is determined 806 that there is spectrum available, i.e., that there is an opportunity to increase communication bandwidth without affecting other radio links, then the radio link proceeds to adjust 807 the bandwidth of the communication frequency band to make use of the available spectrum.

If it is instead determined 806 that there is no available spectrum, then the radio link evaluates 808 a relative priority with respect to the interfering transceiver that has been detected in vicinity of the communication frequency band edge, and if it is determined that the radio link is more important, it will still proceed to occupy 809 more spectral resources, essentially pushing the interfering transmitter out of its way. On the other hand, if it is determined that the relative priority does not merit pushing the interference out of the way, then the radio link investigates if it should proceed to adjust by reducing 803 the occupied spectrum in order to consume less frequency resources, instead making room for neighbouring higher priority radio links.

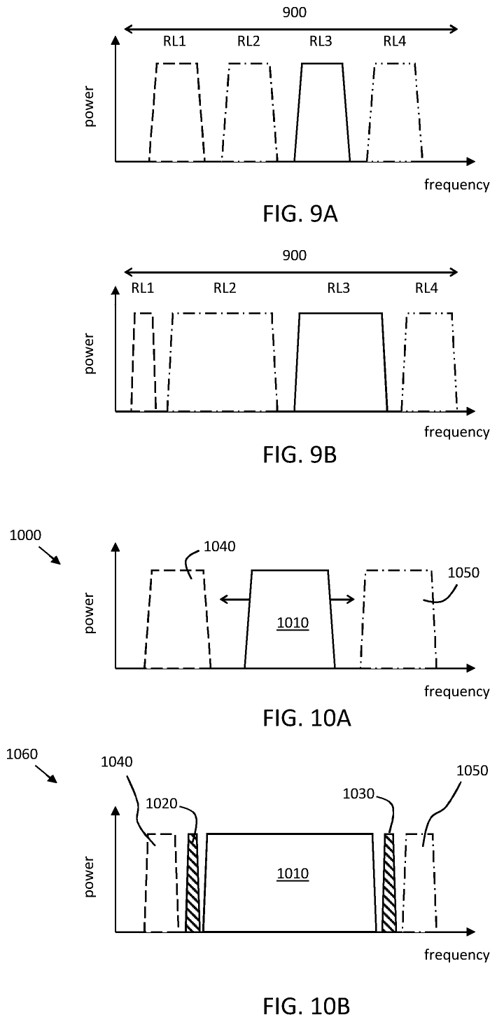

Now, suppose that at least a subset of the transceivers in FIG. 6 implements this type of function for dynamic adjustment of respective communication frequency bands. The result will be a network of radio link transceivers which periodically or even continuously adjusts their respective frequency bands of operation (in terms of bandwidth and/or center frequency) to adjust to both traffic conditions as well as interference conditions in the network. FIGS. 9A and 9B show one such example where four different radio links, RL1-RL4 are initially configured with equally wide communication frequency bands of operation comprised within a block-license frequency band of operation 900. After some time, the traffic load distribution in the network and the interference situation has caused RL1 to decrease the width of its frequency band of operation as well as to shift it to lower frequencies. RL2 has expanded its frequency band of operation to be able to handle more traffic, and has also followed RL1 to lower frequencies. RL3 and RL4, on the other hand, have shifted to higher frequencies. RL3 now operates at a wider communication frequency band, at the expense of RL4 which has backed off to a smaller communication frequency band at the high frequency outskirts of the block-license 900.

FIGS. 10A and 10B illustrate another example operation of the herein disclosed techniques. In this example, the control unit 1400 is arranged to insert a guard carrier 1020, 1030 adjacent to the communication frequency band 220 configured to shield against adjacent interference signals 1040, 1050.

FIG. 10A shows an example scenario 1000 of a radio link signal 1010 initially operating in a communication frequency band, with adjacent interference signals 1040, 1050 at both sides, i.e., at both lower and higher frequencies. It is desired to expand the communication frequency band of the radio link signal 1010.

FIG. 10B illustrates a scenario 1060 following the example scenario 1000 in FIG. 10A, where guard carriers 1020, 1030 have been inserted adjacent to the communication frequency band 220 configured to shield against the adjacent interference signals 1040, 1050, and where the bandwidth of the radio link signal 1010 has been increased at the expense of the adjacent interference signals 1040, 1050.

Thus, a radio link transceiver wishing to push some other radio link transceiver out of the way may use the guard carrier to interfere with the neighboring radio link. The neighboring radio link, in response to detecting the interference from the guard carrier, then starts to back off in order to make more room for its neighbor. This type of guard carrier can be used to protect particularly sensitive radio links from interference by neighboring transmitters. The guard carriers 1020, 1030 will appear as a strong interference as neighboring links try to scavenge more communication resources, and thus act as a deterrent of sorts.

With renewed reference to FIG. 6, there is also disclosed herein a network node arranged as remote server 170, where the remote server 170 is arranged to maintain a database 630 of characterized interference signals 202 in a network of radio link transceivers 110, 115, 160, 510, 520, 610, where each characterized interference signal in the database 630 is associated with a bandwidth and a center frequency, where the network node is arranged to transmit data to one or more radio link transceivers 110, 115, 160, 510, 520, 610 in the network of radio link transceivers, the data being associated with the bandwidths and the center frequencies of at least some of the interference signals. The remote server then acts as intermediary and may distribute the necessary interference characterization information to the radio links. An advantage of this is that the remote server also allows radio links which do not comprise advanced interference characterization ability to participate in the dynamic adjustments of their communication frequency bands of operation.

According to aspects, the database 630 comprises one or more relative priority values, each relative priority value being indicative of a priority of a respective radio link transceiver relative to one or more other radio link, where the network node is arranged to transmit data to one or more radio link transceivers 110, 115, 160, 510, 520, 610 in the network of radio link transceivers, the data being associated with one or more of the relative priority values. Thus, the remote server distributes priority data, which can be configured by the operator in a convenient manner.

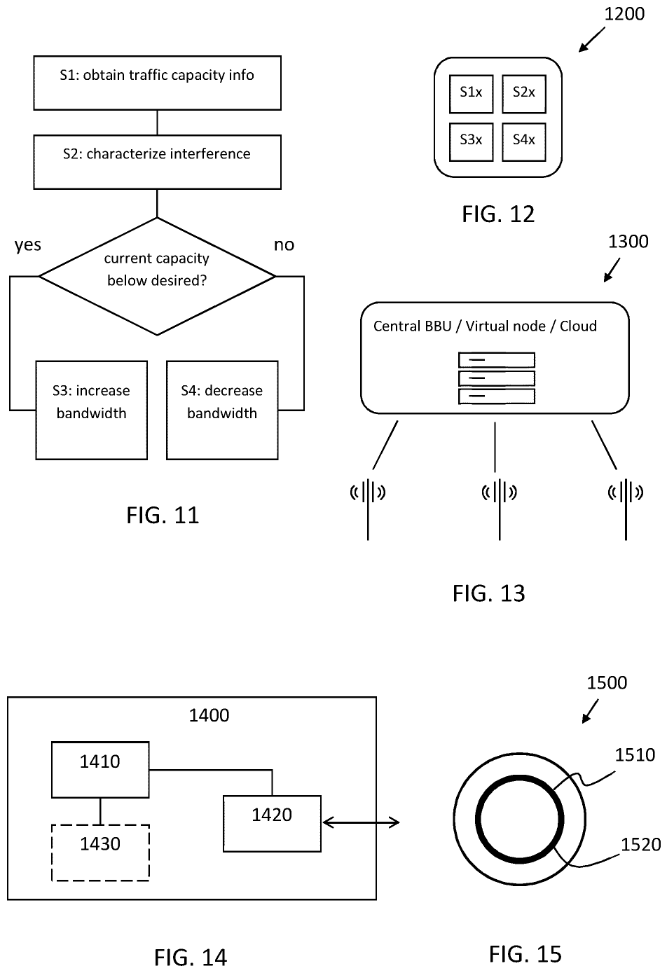

FIG. 11 is a flow chart illustrating a computer implemented method, performed in a control unit 1400 for a microwave radio link, RL, transceiver 110, 115, 160, 510, 520, 610, the method comprises obtaining S1 information related to a current traffic capacity of the RL transceiver and a desired traffic capacity of the RL transceiver, and characterizing S2 at least one interference signal 202 by determining, for each of the at least one interference signal 202, a respective frequency distance 208 from a band edge 206, 207 of a communication frequency band 220 of the RL transceiver to an interference frequency band of the interference signal 202.

The method further comprising, when the current traffic capacity is smaller than the desired traffic capacity, increasing S3 a bandwidth of the communication frequency band 220 by adjusting the communication frequency band 220 of the RL transceiver in dependence of the determined frequency distance, and when the current traffic capacity is larger than the desired traffic capacity, decreasing S4 the bandwidth of the communication frequency band 220 by adjusting the communication frequency band 220 of the RL transceiver in dependence of the determined frequency distance.

FIG. 12 schematically illustrates, in terms of a number of functional modules, the components of a control unit 1200 for a microwave radio link transceiver 110, 115, 160, 510, 520, 610. The control unit comprises an obtaining module Sx1 configured to obtain information related to a current traffic capacity of the RL transceiver and a desired traffic capacity of the RL transceiver, and a characterizing module Sx2 configured to characterize at least one interference signal 202 by determining, for each of the at least one interference signal 202, a respective frequency distance 208 from a band edge 206, 207 of a communication frequency band 220 of the RL transceiver to an interference frequency band of the interference signal 202,
the control unit further comprises a bandwidth increasing module Sx3 configured to, when the current traffic capacity is smaller than the desired traffic capacity, increase a bandwidth of the communication frequency band 220 by adjusting the communication frequency band 220 of the RL transceiver in dependence of the determined frequency distance, and
a bandwidth decreasing module Sx4 configured to, when the current traffic capacity is larger than the desired traffic capacity, decrease the bandwidth of the communication frequency band 220 by adjusting the communication frequency band 220 of the RL transceiver in dependence of the determined frequency distance.

FIG. 13 illustrates various realizations 1300 of the methods, devices and techniques discussed above. The methods and receivers discussed above may be implemented in a baseband processing unit (BBU) which could be deployed in a centralized manner or in a virtual node in the communications network 100. The split between the physical node and the centralized node can be on different levels, e.g. at I/Q samples level from the radio unit. Parts of the proposed methods may of course also be implemented on a remote server comprised in a cloud-based computing platform.

FIG. 14 schematically illustrates, in terms of a number of functional units, the general components of a control unit 1400 according to embodiments of the discussions herein. Processing circuitry 1410 is provided using any combination of one or more of a suitable central processing unit (CPU), multiprocessor, microcontroller, digital signal processor DSP, etc., capable of executing software instructions stored in a computer program product, e.g., in the form of a storage medium 1430. The processing circuitry 1410 may further be provided as at least one application specific integrated circuit ASIC, or field programmable gate array FPGA.

Particularly, the processing circuitry 1410 is configured to cause the device 1400 to perform a set of operations, or steps, such as the methods discussed in connection to FIG. 8 and the discussions above. For example, the storage medium 1430 may store the set of operations, and the processing circuitry 1410 may be configured to retrieve the set of operations from the storage medium 1430 to cause the device to perform the set of operations. The set of operations may be provided as a set of executable instructions. Thus, the processing circuitry 1410 is thereby arranged to execute methods as herein disclosed. In other words, there is shown a network node 1400, comprising processing circuitry 1410, a network interface 1420 coupled to the processing circuitry 1410 and a memory 1430 coupled to the processing circuitry 1410, wherein the memory comprises machine readable computer program instructions that, when executed by the processing circuitry, causes the network node to perform at least some of the techniques disclosed herein.

The storage medium 1430 may also comprise persistent storage, which, for example, can be any single one or combination of magnetic memory, optical memory, solid state memory or even remotely mounted memory.

The device 1400 may further comprise an interface 1420 for communications with at least one external device. As such the interface 1420 may comprise one or more transmitters and receivers, comprising analogue and digital components and a suitable number of ports for wireline or wireless communication.

The processing circuitry 1410 controls the general operation of the device 1400, e.g., by sending data and control signals to the interface 1420 and the storage medium 1430, by receiving data and reports from the interface 1420, and by retrieving data and instructions from the storage medium 1430. Other components, as well as the related functionality, of the control node are omitted in order not to obscure the concepts presented herein.

FIG. 15 illustrates a computer readable medium 1510 carrying a computer program comprising program code means 1520 for performing the methods illustrated in, e.g., FIG. 8 and in FIG. 11, when said program product is run on a computer. The computer readable medium and the code means may together form a computer program product 1500.

1. A control unit for a microwave radio link, (RL) transceiver, wherein the control unit is arranged to:
obtain first traffic capacity information related to a current traffic capacity of the RL transceiver;
obtain second traffic capacity information related to a desired traffic capacity of the RL transceiver; and
characterize at least one interference signal at least by determining, for each of the at least one interference signal, a respective frequency distance from a band edge of a communication frequency band of the RL transceiver to an interference frequency band of the interference signal, wherein
when the current traffic capacity is smaller than the desired traffic capacity, the control unit is further arranged to increase a bandwidth of the communication frequency band by adjusting the communication frequency band of the RL transceiver in dependence of the determined frequency distance, and
when the current traffic capacity is larger than the desired traffic capacity, the control unit is further arranged to decrease the bandwidth of the communication frequency band by adjusting the communication frequency band of the RL transceiver in dependence of the determined frequency distance.

2. The control unit of claim 1, wherein the control unit is further arranged to characterize the at least one interference signal by detecting a center frequency and a frequency bandwidth associated with the interference signal in a received signal of the RL transceiver and/or an adjacent frequency band edge associated with the interference signal.

3. The control unit of claim 1, wherein the control unit is further arranged to characterize the at least one interference signal by receiving data associated with the interference signal from a far end RL transceiver connected via radio link to the RL transceiver.

4. The control unit of claim 1, wherein the control unit is further arranged to characterize the at least one interference signal by receiving data from a remote server, the data being associated with a bandwidth and a center frequency of the interference signal.

5. The control unit of claim 1, wherein the control unit is further arranged to adjust the communication frequency band of the RL transceiver by changing a center frequency of the communication frequency band in addition to the bandwidth of the communication frequency band.

6. The control unit of claim 1, wherein the control unit is further arranged to increase the bandwidth of the communication frequency band only in case a frequency distance to an adjacent interference signal meets a distance acceptance criterion.

7. The control unit of claim 1, wherein the control unit is further arranged to increase the bandwidth of the communication frequency band only in case a signal-to-interference-and-noise ratio and/or a mean-squared-error, associated with the RL transceiver is above a respective distortion acceptance threshold.

8. The control unit of claim 1, wherein the control unit is further arranged to determine a relative priority value of the RL transceiver relative to one or more other RL transceivers, and to increase the bandwidth of the communication frequency band in case the relative priority value is above a priority threshold.

9-10. (canceled)

11. The control unit of claim 8, wherein the control unit is further arranged to periodically increase the bandwidth of the communication frequency band by a step-length with a predetermined probability, where the predetermined probability is configured in dependence of the relative priority value of the RL transceiver.

12. The control unit of claim 1, wherein the control unit is further arranged to adjust a modulation and/or coding configuration of the RL transceiver prior to increasing bandwidth of the communication frequency band.

13. The control unit of claim 1, wherein the control unit is further arranged to decrease the bandwidth in case a frequency distance to an adjacent interference signal is below a distance acceptance threshold.

14. The control unit of claim 1, wherein the control unit is further arranged to decrease the bandwidth in case SINR and/or MSE and/or MCS is below a respective distortion acceptance threshold.

15-16. (canceled)

17. The control unit of claim 1, wherein the desired traffic capacity of the RL transceiver is a function of a current traffic load and/or an average buffer fill level of the RL transceiver.

18. The control unit of claim 1, wherein the desired traffic capacity of the RL transceiver comprises a predicted future traffic pattern of the RL transceiver.

19. (canceled)

20. The control unit of claim 1, wherein the control unit is further configured to increase the bandwidth of the communication frequency band up to but not beyond a block license frequency band.

21. The control unit of claim 1, wherein the control unit is further arranged to autonomously increase and/or decrease the bandwidth of the communication frequency band.

22. A radio link transceiver comprising the control unit of claim 1.

23. A network node arranged to:
maintain a database of characterized interference signals in a network of radio link transceivers, where each characterized interference signal in the database is associated with a bandwidth and a center frequency, and
transmit data to one or more radio link transceivers in the network of radio link transceivers, the data being associated with the bandwidths and the center frequencies of at least some of the interference signals.

24. The network node of claim 23, wherein the database comprises one or more relative priority values, each relative priority value being indicative of a priority of a respective radio link transceiver relative to one or more other radio link, where the network node is arranged to transmit data to one or more radio link transceivers in the network of radio link transceivers, the data being associated with one or more of the relative priority values.

25. A computer implemented method, performed in a control unit for a microwave radio link, (RL) transceiver, the method comprising:
obtaining information related to a current traffic capacity of the RL transceiver and a desired traffic capacity of the RL transceiver;
characterizing at least one interference signal by determining, for each of the at least one interference signal, a respective frequency distance from a band edge of a communication frequency band of the RL transceiver to an interference frequency band of the interference signal;
when the current traffic capacity is smaller than the desired traffic capacity, increasing a bandwidth of the communication frequency band by adjusting the communication frequency band of the RL transceiver in dependence of the determined frequency distance; and
when the current traffic capacity is larger than the desired traffic capacity, decreasing the bandwidth of the communication frequency band by adjusting the communication frequency band of the RL transceiver in dependence of the determined frequency distance.

26-27. (canceled)
